(19) United States
(12) Patent Application Publication
(10) Pub. No.: US 2014/0095847 A1
(43) Pub. Date: Apr. 3, 2014

(54) INSTRUCTION AND HIGHLY EFFICIENT MICRO-ARCHITECTURE TO ENABLE INSTANT CONTEXT SWITCH FOR USER-LEVEL THREADING

(71) Applicant: Doron Orenstein, Haifa (IL)

(72) Inventor: Doron Orenstein, Haifa (IL)

(21) Appl. No.: 13/630,124

(22) Filed: Sep. 28, 2012

(51) Int. Cl. G06F 9/312

(52) U.S. Cl. 712/228; 712/E09.033

(57) ABSTRACT

A processor uses multiple banks of an extended register set to store the contexts of multiple user-level threads. A current bank register provides a pointer to the bank that is currently active. A first thread saves its context (first context) in a first bank of the extended register set and a second thread saves its context (second context) in a second bank of the extended register set. When the processor receives an instruction for exchanging contexts between the first thread and the second thread, the processor changes the pointer from the first bank to the second bank, and executes the second thread using the second context stored in the second bank.

### TECHNICAL FIELD

The present disclosure pertains to the field of processing logic, microprocessors, and associated instruction set architecture that, when executed by the processor or other processing logic, perform logical, mathematical, or other functional operations.

### BACKGROUND ART

An instruction set, or instruction set architecture (ISA), is the part of the computer architecture related to programming, and may include the native data types, instructions, register architecture, addressing modes, memory architecture, interrupt and exception handling, and external input and output (I/O). The term instruction generally refers herein to macro-instructions—that is instructions that are provided to the processor (or instruction converter that translates (e.g., using static binary translation, dynamic binary translation including dynamic compilation), morphs, emulates, or otherwise converts an instruction to one or more other instructions to be processed by the processor) for execution—as opposed to micro-instructions or micro-operations (micro-ops)—that is the result of a processor's decoder decoding macro-instructions.

The ISA is distinguished from the micro-architecture, which is the internal design of the processor implementing the instruction set. Processors with different micro-architectures can share a common instruction set. For example, Intel® Core™ processors and processors from Advanced Micro Devices, Inc. of Sunnyvale, Calif. implement nearly identical versions of the x86 instruction set (with some extensions that have been added with newer versions), but have different internal designs. For example, the same register architecture of the ISA may be implemented in different ways in different micro-architectures using well-known techniques, including dedicated physical registers, one or more dynamically allocated physical registers using a register renaming mechanism, etc.

Modern processor cores generally support multithreading to improve its performance efficiency. For example, Intel® Xeon™ cores currently provide 2-way simultaneous multithreading (SMT). Increasing the number of threads per core can bring higher performance to key server applications. However, increasing the number of SMT threads (from two to four or more) is very complex, costly and error-prone.

An alternative multithreading approach is to implement user-level threads managed by application software. For example, Microsoft® systems use software mechanisms to manage user-level threads called fibers. Using the fiber or a similar approach, an application can switch from a first fiber to a second fiber when the first fiber encounters a long latency event (e.g., I/O, a non-user event, wait-for-semaphore, etc.). The management and execution of fibers can be fully handled and carefully tuned by the application. However, performance improvement by the fiber approach is quite limited due to the costly switch penalty between fibers (e.g., save, restore, branch operations), and due to the limitations of software in figuring out efficiently when to switch for both short and long latency hardware stall events.

### BRIEF DESCRIPTION OF THE DRAWINGS

Embodiments are illustrated by way of example and not limitation in the Figures of the accompanying drawings:

FIG. 1A is a block diagram of an instruction processing apparatus having an extended register set according to one embodiment.

FIG. 1B is a block diagram of register architecture having an extended register set according to one embodiment.

FIG. 2A illustrates an example of memory regions for storing multiple hiber contexts according to one embodiment.

FIG. 2B illustrates an example of an extended register set including banks for storing multiple hiber contexts according to one embodiment.

FIG. 2C illustrates another example of an extended register set including banks for storing multiple hiber contexts according to one embodiment.

FIG. 3 illustrates an example of vector registers divided into partitions for storing multiple hiber contexts according to one embodiment.

FIG. 4A illustrates an example of a program including an instruction that is likely to cause cache misses.

FIG. 4B illustrates an example of using state exchange instructions for executing multiple hibers.

FIG. 5 is a flow diagram illustrating operations to be performed according to one embodiment.

FIG. 6 is a block diagram illustrating the use of a software instruction converter to convert binary instructions in a source instruction set to binary instructions in a target instruction set according to one embodiment.

FIG. 7A is a block diagram of an in-order and out-of-order pipeline according to one embodiment.

FIG. 7B is a block diagram of an in-order and out-of-order core according to one embodiment.

FIGS. 8A-B are block diagrams of a more specific exemplary in-order core architecture according to one embodiment.

FIG. 9 is a block diagram of a processor according to one embodiment.

FIG. 10 is a block diagram of a system in accordance with one embodiment.

FIG. 11 is a block diagram of a second system in accordance with one embodiment.

FIG. 12 is a block diagram of a third system in accordance with an embodiment of the invention.

FIG. 13 is a block diagram of a system-on-a-chip (SoC) in accordance with one embodiment.

### DESCRIPTION OF THE EMBODIMENTS

In the following description, numerous specific details are set forth. However, it is understood that embodiments of the invention may be practiced without these specific details. In other instances, well-known circuits, structures and techniques have not been shown in detail in order not to obscure the understanding of this description.

Embodiments described herein provide a set of state exchange instructions (e.g., SXCHG, SXCHGL and their variants), with appropriate micro-architectural support, that causes a processor to perform an instant switch (with near-zero-cycle penalty) between user-level threads. No additional changes to the ISA are necessary. These user-levels threads are referred to hereinafter as “hibers,” which are hardware supported fibers. The set of instructions enable software to rapidly switch among N hibers by saving and restoring register content (also referred to as “register state”) in N banks of user-mode (ring-3) registers. This switching can be controlled by the applications without involvement of an operating system. These N-banks of user-mode registers are herein referred to as an extended register set. The number N can be 2, 4, 8, or any number that is supported by the micro-architecture.

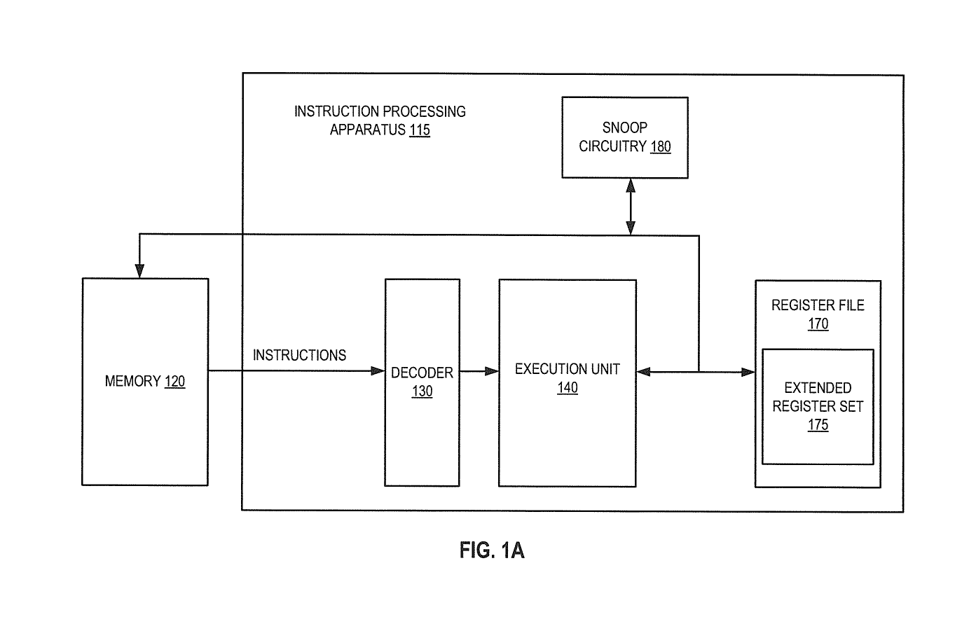

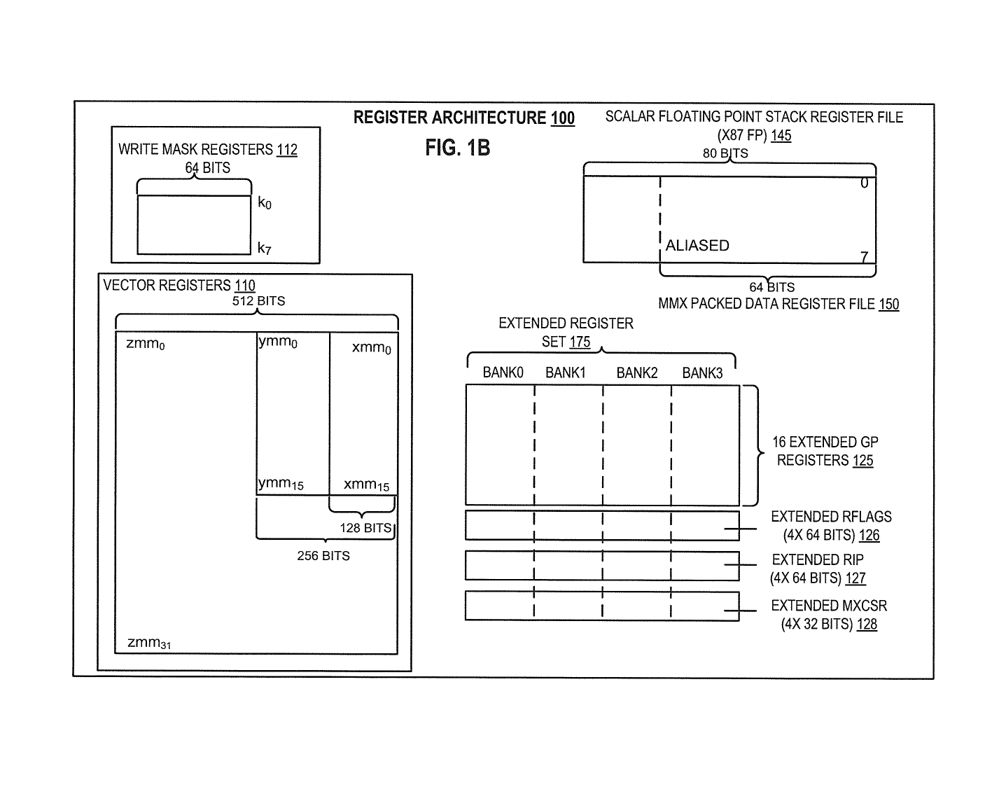

FIG. 1A is a block diagram of an embodiment of an instruction processing apparatus 115 having an execution unit 140 operable to execute instructions. In some embodiments, the instruction processing apparatus 115 may be a processor, a processor core of a multi-core processor, or a processing element in an electronic system.

A decoder 130 receives incoming instructions in the form of higher-level machine instructions or macroinstructions, and decodes them to generate lower-level micro-operations, micro-code entry points, microinstructions, or other lower-level instructions or control signals, which reflect and/or are derived from the original higher-level instruction. The lower-level instructions or control signals may implement the operation of the higher-level instruction through lower-level (e.g., circuit-level or hardware-level) operations. The decoder 130 may be implemented using various different mechanisms. Examples of suitable mechanisms include, but are not limited to, microcode, look-up tables, hardware implementations, programmable logic arrays (PLAs), other mechanisms used to implement decoders known in the art, etc.

The execution unit 140 is coupled to the decoder 130. The execution unit 140 may receive from the decoder 130 one or more micro-operations, micro-code entry points, microinstructions, other instructions, or other control signals, which reflect, or are derived from the received instructions. The execution unit 140 also receives input from and generates output to a register file 170 or a memory 120.

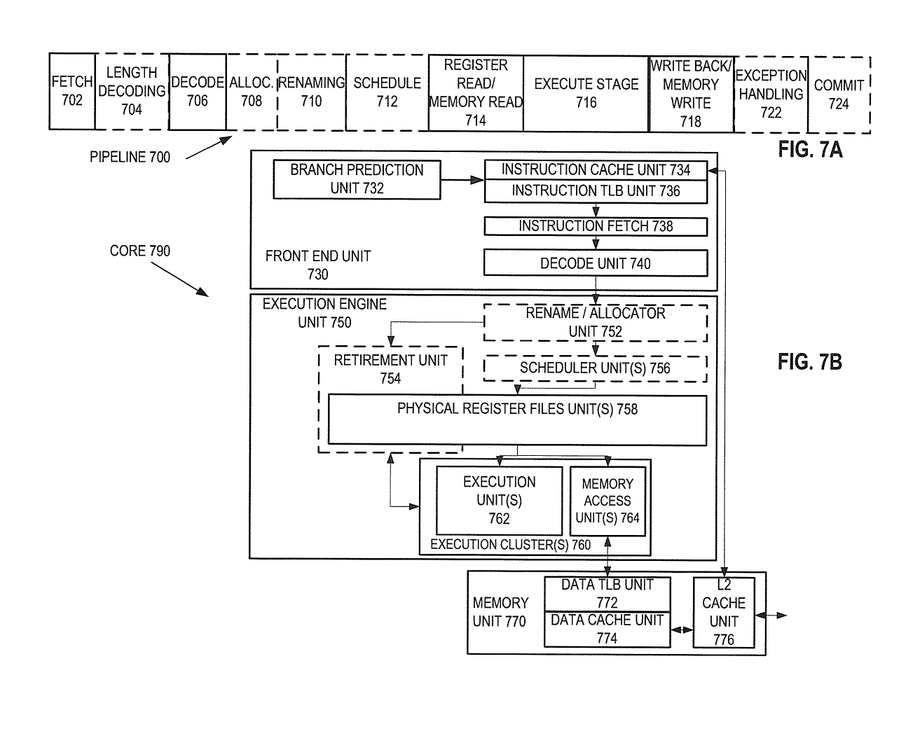

To avoid obscuring the description, a relatively simple instruction processing apparatus 115 has been shown and described. It is to be appreciated that other embodiments may have more than one execution unit. For example, the apparatus 115 may include multiple different types of execution units, such as, for example, arithmetic units, arithmetic logic units (ALUs), integer units, floating point units, etc. Still other embodiments of instruction processing apparatus or processors may have multiple cores, logical processors, or execution engines. A number of embodiments of the instruction processing apparatus 115 will be provided later with respect to FIGS. 7-13.

According to one embodiment, the memory 120 stores the contexts of multiple hibers. The hiber contexts being stored include the register state of the multiple hibers. When a computer system (e.g., a processor running a compiler or other optimization code, prediction or optimization circuitry, etc.) or a programmer predicts that a specific instruction in an application may cause a stall in one of its hibers, an instruction is inserted into the application to cause the execution unit 140 to switch the execution from one hiber to another hiber.

To improve processing performance, hiber context is not necessarily stored in and restored from the memory 120 wherever there is a hiber switch. In one embodiment, the instruction processing apparatus 115 may use the extended register set 175 as a “write-back cache” for temporarily storing hiber context to reduce the frequency of memory access. Accessing the hiber context from the extended register set 175 is much faster than accessing the same from the memory 120. Thus, the speed of context switching among hibers can be significantly increased.

However, by not constantly storing and restoring hiber contexts in the memory 120, the memory 120 may not have the up-to-date hiber context. To avoid the out-dated information in the memory 120 being accessed by any applications or threads (which run concurrently on the cores or processors of the instruction processing apparatus 115), the instruction processing apparatus 115 uses snoop circuitry 180 to track access to the memory regions in which hiber context is stored. Whenever the content of any of these memory regions is to become incoherent with (i.e., different from) the current register content, the corresponding memory addresses are marked in the snoop circuitry 180 as a marked area. A write-back event (e.g., a microcode trap) is triggered when the marked area is to be read from or is written into in order to synchronize the stored contexts between the marked area and the extended register set 175. This microcode trap causes current register state (i.e., the updated hiber context) to be written to the marked area (if any application or thread is trying to read from the area), or re-load the registers from the marked area (if another application or thread has written to the area).

In one embodiment, the instruction processing apparatus 115 supports a set of hiber-switching instructions, such as a State Exchange (SXCHG) instruction and its variants. The set of hiber-switching instructions include a basic SXCHG(I, J), where the context of hiber[I] is saved into the memory 120 and the context of hiber[J] is restored and cleared from the memory 120. The set of hiber-switching instructions also include SXCHG (without operands), SXCHGL (a light version of SXCHG), SXCHG.u (unconditional SXCHG), SXCHG.c (conditional SXCHG) and <SXCHG.start-SXCHG.end> (block SXCHG), and the like. These instructions will be explained in detail below.

Before describing the hiber-switching instructions, it is useful to show an embodiment of underlying register architecture that supports these instructions. The register architecture to be described with reference to FIG. 1B is based on the Intel® Core™ processors implementing an instruction set including x86, MMX™, Streaming SIMD Extensions (SSE), SSE2, SSE3, SSE4.1, and SSE4.2 instructions, as well as an additional set of SIMD extensions, referred to the Advanced Vector Extensions (AVX) (AVX1 and AVX2). However, it is understood different register architecture that supports different register lengths, different register types and/or different numbers of registers can also be used.

FIG. 1B is a block diagram of a register architecture 100 according to one embodiment of the invention. In the embodiment illustrated, there are thirty-two vector registers 110 that are 512 bits wide; these registers are referenced as zmm0 through zmm31. The lower order 256 bits of the lower sixteen zmm registers are overlaid on registers ymm0-16. The lower order 128 bits of the lower sixteen zmm registers (the lower order 128 bits of the ymm registers) are overlaid on registers xmm0-15. In the embodiment illustrated, there are eight write mask registers 112 (k0 through k7), each 64 bits in size. In an alternate embodiment, the write mask registers 112 are 16 bits in size.

In the embodiment illustrated, the extended register set 175 includes four banks of sixteen 64-bit general-purpose (GP) registers, referred to herein as extended GP registers 125. In an embodiment they are used along with the existing x86 addressing modes to address memory operands. These registers (in each bank) are referenced by the names RAX, RBX, RCX, RDX, RBP, RSI, RDI, RSP, and R8 through R15. The embodiment also illustrates that the extended register set 175 includes extended RFLAGS registers 126, extended RIP registers 127 and extended MXCSR registers 128, all of which include four banks.

The embodiment also illustrates a scalar floating point (FP) stack register file (x87 stack) 145, on which is aliased the MMX packed integer flat register file 150. in the embodiment illustrated, the x87 stack is an eight-element stack used to perform scalar floating-point operations on 32/64/80-bit floating point data using the x87 instruction set extension; while the MMX registers are used to perform operations on 64-bit packed integer data, as well as to hold operands for some operations performed between the MMX and XMM registers.

In one embodiment, the extended register set 175 may additionally include four banks of FP stack register file 145 and/or four banks of vector registers 110 to provide temporary storage for up to four hibers with respect to their FP register state and/or vector register state.

Alternative embodiments of the invention may use wider or narrower registers and/or more or few register banks. Additionally, alternative embodiments of the invention may use more, less, or different register files and registers.

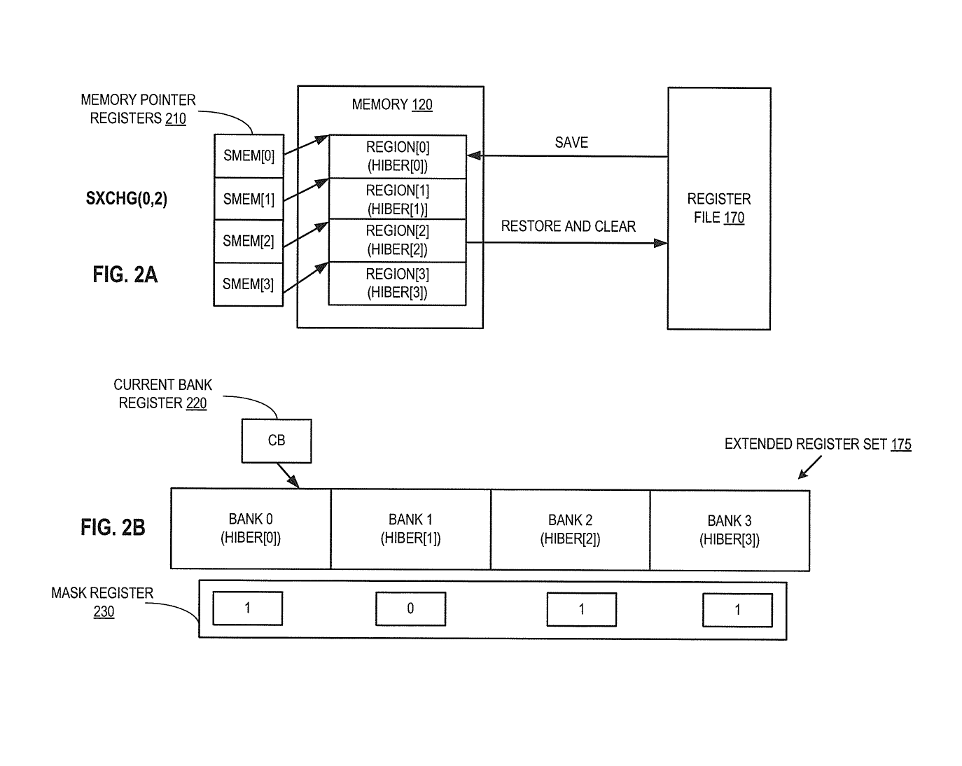

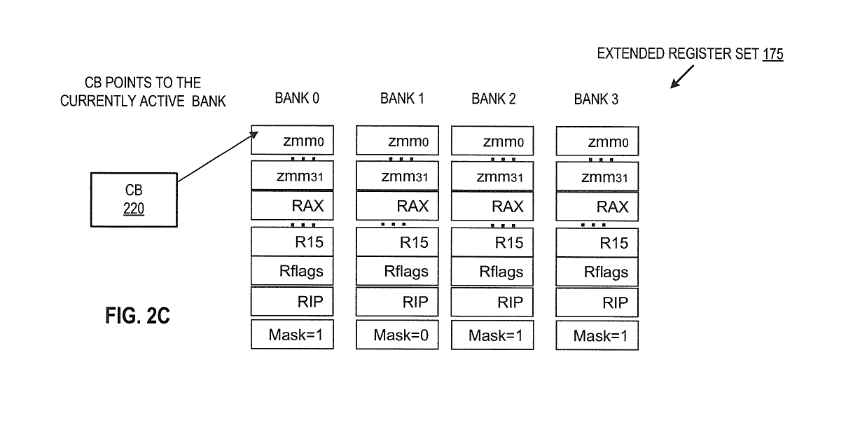

FIG. 2A is a diagram illustrating the operation performed by a processor (e.g., the instruction processing apparatus 115) responsive to the basic SXCHG(I, J) instruction according to one embodiment. In this embodiment, the memory 120 is configured to include four regions, where different regions are designated to store the contexts of different hibers. The basic SXCHG(I, J) has two operands—a source(I) indicating which hiber context is to be saved, and a destination(J) indicating which hiber context is to be restored. In response to this instruction, the processor saves the current content of registers to the memory 120. In one embodiment, these registers includes one or more of the GP registers (e.g., RAX, RBX . . . , R15), vector registers (e.g., zmm0-31), flag registers (e.g., RFLAGS), instruction pointer (e.g., RIP), MXCSR, and any combinations thereof. The current content of these registers is saved into a designated memory region (region[I]) pointed to by a memory pointer register 210 (SMEM[I]). After saving the current register content, the processor loads the above registers from another memory region (region[J]) pointed to by the memory pointer register SMEM[J], and clears (i.e., zeros out) this memory region (region[J]). As a result of this operation, the processor switches from one instruction flow hiber[I] to execute another instruction flow hiber[J]

In one scenario, hiber[J] may include an instruction SXCHG(J, I), which causes the processor to switch back to execute the previous instruction flow (i.e., hiber[I]) with the register content stored in memory region[I]. Responsive to SXCHG(J, I), the processor saves the registers state in the memory region (region[J]) pointed to by SMEM[J], loads the registers from the memory region (region[I]) pointed to by SMEM[I] and clears (i.e., zeros out) this memory region (region[I]).

The example of FIG. 2A shows memory region[0], region[1], region[2] and region[3]. The execution of SXCHG(0,2) results in saving the register content into region[0] (pointed to by SMEM[0]) and restoring the register content from region[2] (pointed to by SMEM[2]).

To improve the speed of user-level context switching, register state can be saved and restored from an extended register set (e.g., the extended register set 175 of FIGS. 1A and 1B) instead of the memory. Mapping memory locations into physical registers is sometimes referred to as memory renaming.

FIG. 2B illustrates an embodiment of the extended register set 175. In this embodiment, each register in the set 175 has four banks: bank 0, bank 1, bank 2 and bank 3. Micro-architecture that supports the SXCHG instructions with improved performance can have multiple banks; e.g., four banks, with the GP registers in each bank being 64 bit wide. In the embodiment of FIG. 2B, a register in a given bank is renamed by its original name appended with a bank index; e.g., RAX.0, RAX.1, RAX.2 and RAX.3. When the processor switches between two hiber contexts, instead of long sequence of memory save and memory restore operations, the processor only needs to change a pointer (e.g., the content of a current bank (CB) register 220) from one register bank to another. In one embodiment, the decoder can change a register name (e.g., from RAX.0 to RAX.3) referred to by instructions upon a context switch. An advanced out-of-order processor with register renaming can easily switches the rename pointer. As a result, if the processor front end predicts the SXCHG, hiber switch can be performed swiftly in near zero cycle.

One embodiment of the SXCHG instruction does not have any operands. Instead of supplying the source index (e.g., index I), the instruction uses the CB register 220 to identify the bank of the currently-active hiber that the processor is executing. Following a SXCHG instruction (e.g., when a write-back event occurs), the processor saves the current register state into the memory region pointed to by SMEM[CB]. In the example of FIG. 2B, CB=0, which means the processor saves register state in SMEM[0]. The register state in bank 0 of the extended register set 175 should stay in bank 0 for future use; e.g., when the execution switches back to hiber[0].

Moreover, the SXCHG instruction does not need a destination index. Instead, the processor uses a mask register 230 which includes a mask bit for each of the hibers. In the example of FIG. 2B, each hiber has an associated mask bit. If the associated mask bit has a predetermined value (e.g., zero), the corresponding hiber is deactivated and no switch will be made into this hiber. Otherwise (e.g., when the mask bit value is one), the corresponding hiber is active (currently being executed) or sleeping (waiting to be executed). Upon SXCHG execution, the processor will switch to and activate the next hiber that is sleeping, using a round-robin or similar policy. In the example of FIG. 2B, the processor switches from CB=0 to CB=2 because the mask bit of hiber[1] is zero.

FIG. 2C illustrates an embodiment of the extended register set 175 in further detail. In this embodiment, the extended register set 175 includes four banks, and each bank includes zmm0-31, the GP registers, the RFLAGS, and the RIP. As described before, the mask register 230 includes a mask bit for each bank to indicate whether the corresponding is deactivated, and the CB register 220 points to the currently active bank. Although the widths of the registers in the same bank appear to be the same in FIG. 2C, it is understood that different registers in the same bank may or may not have the same widths. In alternative embodiments, the extended register set 175 may include more of fewer registers, and/or more or fewer number of banks.

In one embodiment, the SXCHG instruction has a number of variants. SXCHG.0 is an instruction that causes an unconditional switch to a next hiber. SXCHG.c is an instruction that causes a switch to the next hiber based on the runtime decision of the micro-architecture. In one embodiment, the decision-making micro-architecture may be the front end circuitry (e.g., the branch prediction unit), which tracks the instruction pointer for frequently missed loads. Based on hardware parameters, the micro-architecture may determine whether a condition is met for performing a switch and, if a switch is to be performed, at which point of execution to perform the switch. For example, the micro-architecture can decide to switch upon a prefetch cache miss or other long latency events. SXCHG.start and SXCHG.end are a pair of instructions that mark the boundary of a block of instructions in which every instruction can be a candidate to have an SXCHG context switch. This has the same effect as having SXCHG.c before every instruction in that instruction block. The SXCHG.start and SXCHG.end mark the beginning and the end of the instruction block, respectively. By using such a marking, the micro-architecture can freely select among the instructions to execute different hibers.

In one embodiment, the SXCHG instruction and its variants have a “light” version called SXCHGL. In response to an SXCHGL instruction, the processor does not save and restore hiber context in memory. Instead, the processor saves and restores hiber context in unutilized registers on-die, such as vector registers and/or floating point registers. In one embodiment, these unutilized registers are the vector registers (e.g., zmm0-31, zmm16-31, or any unutilized portion of the zmm registers). In one embodiment, a portion of the zmm registers can still be used for vector storage (e.g., xmm0-15) and the rest of the zmm registers can be used for storing hiber context. These unutilized registers (or a portion thereof) can be divided into multiple partitions (e.g., four partitions corresponding to the four memory regions in SXCHG) for storing the context of multiple hibers. Additionally, similar to SXCHG, the SXCHGL instruction also has a number of variants: SXCHGL.u, SXCHGL.c, SXCHGL.start and SXCHGL.end; their use is analogous to their SXCHG counterparts.

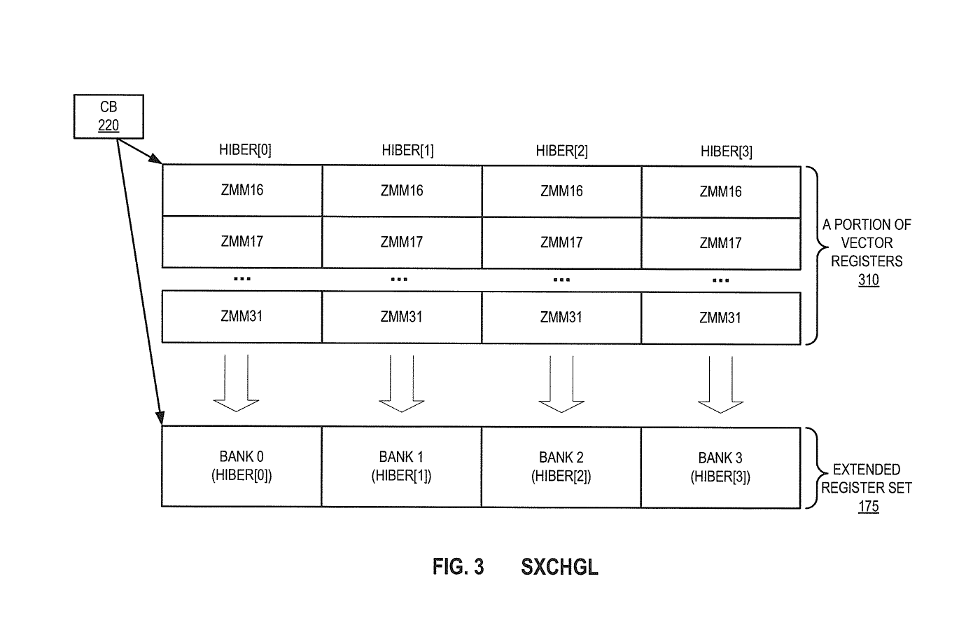

In one embodiment, the context saved in response to SXCHG instructions includes zmm register state; whereas the context saved in response to SXCHGL instructions includes xmm register state (but not the zmm register state). Thus, for SXCHGL instructions, zmm0-15 can be used to store the xmm state of four hibers, and zmm16-31 can be used to store the other registers' state (e.g., GP registers, flags registers, instruction pointer, etc.) of the same four hibers. FIG. 3 illustrates an embodiment of a portion of vector registers 310 (zmm16-31) divided into four partitioned for storing the contexts of four hibers; each partition corresponding to a bank of the extended register set 175. The CB register 220 provides a pointer to the currently active bank of the extended register set 175 as well as the corresponding partition of the portion of vector registers 310.

Executing an SXCHGL instruction by a direct save/restore of registers from/to zmm registers can be slow. To enable an efficient implementation, instead of saving and restoring registers from/to zmm registers, an extended register set (e.g., the extended register set 175 of FIGS. 1A and 1B) including multiple banks can be used as a “write-back cache” in a manner similar to SXCHG. Similar to SXCHG, a CB register can be used by SXCHGL to point to the currently active bank, and a mask register including mask bits can be used to indicate whether a corresponding bank is no longer in use (i.e., deactivated). If all of the hibers are masked (e.g., having corresponding mask bits of zeros), SXCHGL becomes a no-op operation.

As a result, a processor may execute code from multiple hibers efficiently. If the front end correctly predicts SXCHGL, the processor can switch between hibers very fast without a pipeline flush.

In one embodiment, a snoop mechanism similar to the snoop circuitry 180 of FIG. 1A can be used to track access to the zmm registers in which hiber contexts are stored. Whenever a hiber context stored in a zmm register is to become incoherent with (i.e., different from) the corresponding content of the extended register set 175, the zmm register is marked. In one embodiment, this snoop mechanism can be implemented as a state bit associated with each global status of the zmm register. The state bit indicates where the latest updated hiber context is. If the latest update is in the zmm registers (e.g., after an XRESTORE operation), the first SXCHGL instruction execution will trigger a write-back event which causes a micro-code sequence to be executed. The micro-code sequence will copy the latest update from the zmm space to the extended register set 175. If the latest update is in the extended register set 175 and the processor starts to execute a vector instruction (e.g., after an XSAVE operation), the micro-code will copy the latest update from the extended register set 175 to the zmm space.

In the following description, wherever SXCHG or “state exchange instruction” is mentioned, it is understood that the description applies to both SXCHG and SXCHGL.

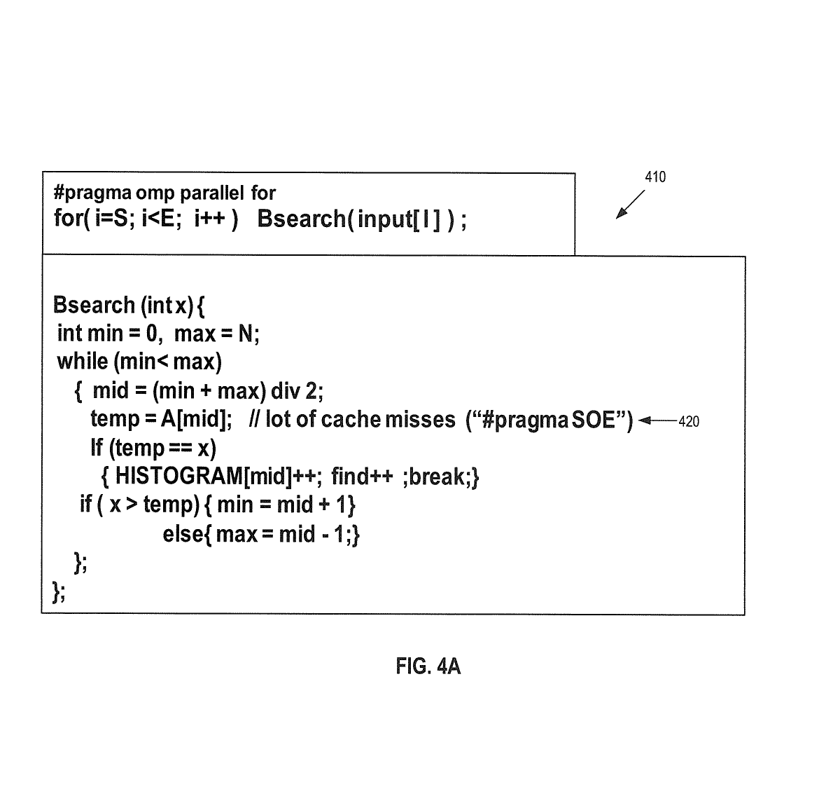

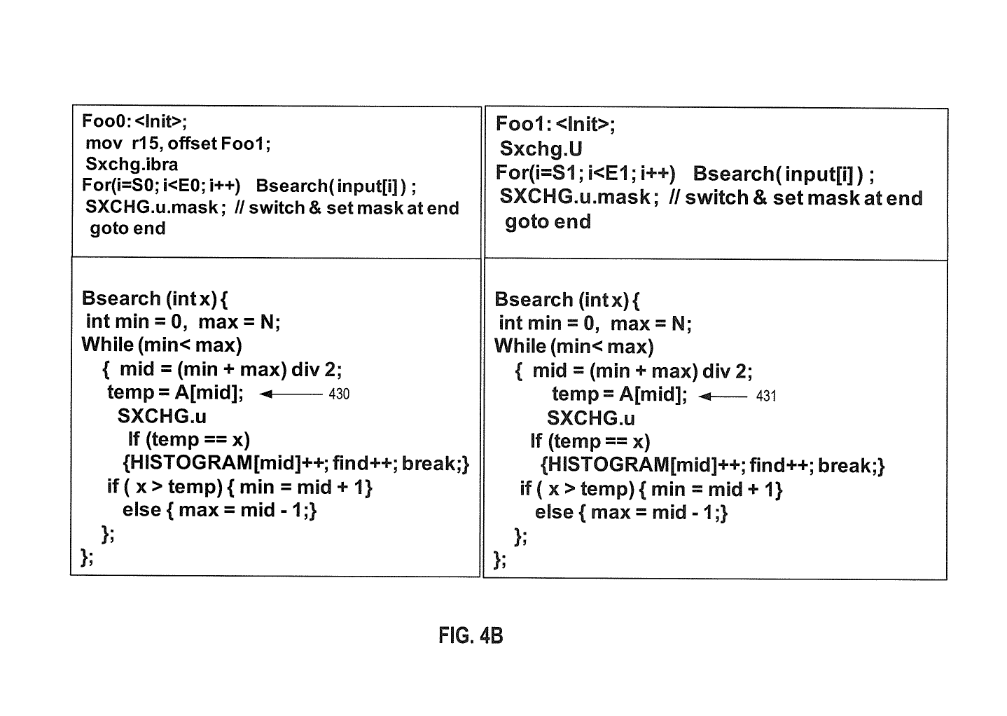

FIG. 4A illustrates an example of a code segment 410 that may use the SXCHG instruction or one of its variants described above. The code segment 410 implements binary search (referred to as “Bsearch”). During the binary search, a large number of cache misses are expected to occur at instruction 420 (temp=A[mid]). FIG. 4B illustrates an example of performing the same binary search with two code segments foo0 and foo1, each of which represents a hiber. Each of the code segments includes a SXCHG.0 instruction after the (temp=A[mid]) instruction (430 or 431), where a lot of cache misses are expected to occur. Thus, immediately after the processor executes the instruction 430 in foo0, the processor executes an unconditional switch to foo1 during the expected cache miss event. If a cache miss indeed occurs to the instruction 430, the context switch allows the processor to engage in other useful work in foo1. Similarly, if a cache miss indeed occurs to the instruction 431, the context switch allows the processor to engage in other useful work in foo0. If a cache miss does not occur, the penalty of the context switch is minimal. This is because the contexts of foo0 and foo1 are both stored in the extended register set and can be quickly saved and restored.

In one embodiment, the SXCHG instruction (e.g., the SXCHG.0 instruction in FIG. 4B) can be added by a programmer. In an alternative embodiment, the SXCHG instruction can be added by a compiler. The compiler can be a static compiler or a just-in-time compiler. The compiler can be located on the same hardware platform as the processor executing the SXCHG instruction, or on a different hardware platform. It is noted that the placement of SXCHG and execution of SXCHG have no operating system involvement.

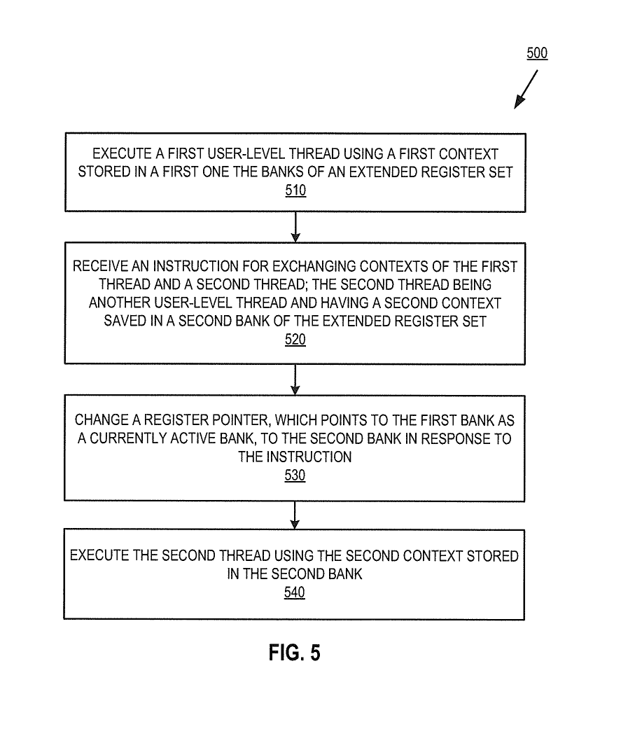

FIG. 5 is a block flow diagram of a method 500 for exchanging two hiber contexts according to one embodiment. The method 500 begins with a processor (e.g., the instruction processing apparatus 115 of FIG. 1A) executing a first user-level thread (e.g., a hyber) using a first context stored in a first bank of an extended register set (block 510). During execution of the first thread, the processor receives an instruction for exchanging contexts of the first thread and a second thread (block 520), where the second thread is another user-level thread (e.g., a hyber) and has a second context saved in a second bank of the extended register set. In response to the instruction, the processor changes a register pointer, which currently points to the first bank as a currently active bank, to the second bank (block 530). The processor then executes the second thread using the second context stored in the second bank (block 540).

In various embodiments, the method of FIG. 5 may be performed by a general-purpose processor, a special-purpose processor (e.g., a graphics processor or a digital signal processor), or another type of digital logic device or instruction processing apparatus. In some embodiments, the method of FIG. 5 may be performed by the instruction processing apparatus 115 of FIG. 1A, or a similar processor, apparatus, or system, such as the embodiments shown in FIGS. 7-13. Moreover, the instruction processing apparatus 115 of FIG. 1A, as well as the processor, apparatus, or system shown in FIGS. 7-13 may perform embodiments of operations and methods either the same as, similar to, or different than those of the method of FIG. 5.

In some embodiments, the instruction processing apparatus 115 of FIG. 1 may operate in conjunction with an instruction converter that converts an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

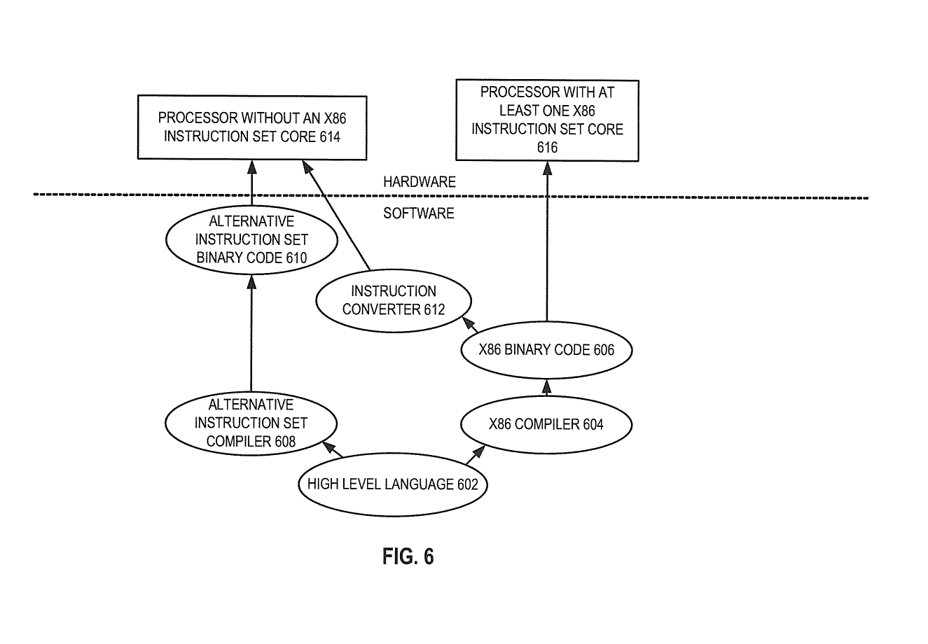

FIG. 6 is a block diagram contrasting the use of a software instruction converter according to embodiments of the invention. In the illustrated embodiment, the instruction converter is a software instruction converter, although alternatively the instruction converter may be implemented in software, firmware, hardware, or various combinations thereof. FIG. 6 shows a program in a high level language 602 may be compiled using an x86 compiler 604 to generate x86 binary code 606 that may be natively executed by a processor with at least one x86 instruction set core 616. The processor with at least one x86 instruction set core 616 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 604 represents a compiler that is operable to generate x86 binary code 606 (e.g., object code) that can, with or without additional linkage processing, be executed on the processor with at least one x86 instruction set core 616. Similarly, FIG. 6 shows the program in the high level language 602 may be compiled using an alternative instruction set compiler 608 to generate alternative instruction set binary code 610 that may be natively executed by a processor without at least one x86 instruction set core 614 (e.g., a processor with cores that execute the MIPS instruction set of MIPS Technologies of Sunnyvale, Calif. and/or that execute the ARM instruction set of ARM Holdings of Sunnyvale, Calif.). The instruction converter 612 is used to convert the x86 binary code 606 into code that may be natively executed by the processor without an x86 instruction set core 614. This converted code is not likely to be the same as the alternative instruction set binary code 610 because an instruction converter capable of this is difficult to make; however, the converted code will accomplish the general operation and be made up of instructions from the alternative instruction set. Thus, the instruction converter 612 represents software, firmware, hardware, or a combination thereof that, through emulation, simulation or any other process, allows a processor or other electronic device that does not have an x86 instruction set processor or core to execute the x86 binary code 606.

### Exemplary Core Architectures

### In-Order and Out-of-Order Core Block Diagram

FIG. 7A is a block diagram illustrating both an exemplary in-order pipeline and an exemplary register renaming, out-of-order issue/execution pipeline according to embodiments of the invention. FIG. 7B is a block diagram illustrating both an exemplary embodiment of an in-order architecture core and an exemplary register renaming, out-of-order issue/execution architecture core to be included in a processor according to embodiments of the invention. The solid lined boxes in FIGS. 7A and 7B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 7A, a processor pipeline 700 includes a fetch stage 702, a length decode stage 704, a decode stage 706, an allocation stage 708, a renaming stage 710, a scheduling (also known as a dispatch or issue) stage 712, a register read/memory read stage 714, an execute stage 716, a write back/memory write stage 718, an exception handling stage 722, and a commit stage 724.

FIG. 7B shows processor core 790 including a front end unit 730 coupled to an execution engine unit 750, and both are coupled to a memory unit 770. The core 790 may be a reduced instruction set computing (RISC) core, a complex instruction set computing (CISC) core, a very long instruction word (VLIW) core, or a hybrid or alternative core type. As yet another option, the core 790 may be a special-purpose core, such as, for example, a network or communication core, compression engine, coprocessor core, general purpose computing graphics processing unit (GPGPU) core, graphics core, or the like.

The front end unit 730 includes a branch prediction unit 732 coupled to an instruction cache unit 734, which is coupled to an instruction translation lookaside buffer (TLB) 736, which is coupled to an instruction fetch unit 738, which is coupled to a decode unit 740. The decode unit 740 (or decoder) may decode instructions, and generate as an output one or more micro-operations, micro-code entry points, microinstructions, other instructions, or other control signals, which are decoded from, or which otherwise reflect, or are derived from, the original instructions. The decode unit 740 may be implemented using various different mechanisms. Examples of suitable mechanisms include, but are not limited to, look-up tables, hardware implementations, programmable logic arrays (PLAs), microcode read only memories (ROMs), etc. In one embodiment, the core 790 includes a microcode ROM or other medium that stores microcode for certain macroinstructions (e.g., in decode unit 740 or otherwise within the front end unit 730). The decode unit 740 is coupled to a rename/allocator unit 752 in the execution engine unit 750.

The execution engine unit 750 includes the rename/allocator unit 752 coupled to a retirement unit 754 and a set of one or more scheduler unit(s) 756. The scheduler unit(s) 756 represents any number of different schedulers, including reservations stations, central instruction window, etc. The scheduler unit(s) 756 is coupled to the physical register file(s) unit(s) 758. Each of the physical register file(s) units 758 represents one or more physical register files, different ones of which store one or more different data types, such as scalar integer, scalar floating point, packed integer, packed floating point, vector integer, vector floating point—status (e.g., an instruction pointer that is the address of the next instruction to be executed), etc. In one embodiment, the physical register file(s) unit 758 comprises a vector registers unit, a write mask registers unit, and a scalar registers unit. These register units may provide architectural vector registers, vector mask registers, and general purpose registers. The physical register file(s) unit(s) 758 is overlapped by the retirement unit 754 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 754 and the physical register file(s) unit(s) 758 are coupled to the execution cluster(s) 760. The execution cluster(s) 760 includes a set of one or more execution units 762 and a set of one or more memory access units 764. The execution units 762 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 756, physical register file(s) unit(s) 758, and execution cluster(s) 760 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 764). It should also be understood that where separate pipelines are used, one or more of these pipelines may be out-of-order issue/execution and the rest in-order.

The set of memory access units 764 is coupled to the memory unit 770, which includes a data TLB unit 772 coupled to a data cache unit 774 coupled to a level 2 (L2) cache unit 776. In one exemplary embodiment, the memory access units 764 may include a load unit, a store address unit, and a store data unit, each of which is coupled to the data TLB unit 772 in the memory unit 770. The instruction cache unit 734 is further coupled to a level 2 (L2) cache unit 776 in the memory unit 770. The L2 cache unit 776 is coupled to one or more other levels of cache and eventually to a main memory.

By way of example, the exemplary register renaming, out-of-order issue/execution core architecture may implement the pipeline 700 as follows: 1) the instruction fetch 738 performs the fetch and length decoding stages 702 and 704; 2) the decode unit 740 performs the decode stage 706; 3) the rename/allocator unit 752 performs the allocation stage 708 and renaming stage 710; 4) the scheduler unit(s) 756 performs the schedule stage 712; 5) the physical register file(s) unit(s) 758 and the memory unit 770 perform the register read/memory read stage 714; the execution cluster 760 perform the execute stage 716; 6) the memory unit 770 and the physical register file(s) unit(s) 758 perform the write back/memory write stage 718; 7) various units may be involved in the exception handling stage 722; and 8) the retirement unit 754 and the physical register file(s) unit(s) 758 perform the commit stage 724.

The core 790 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 790 includes logic to support a packed data instruction set extension (e.g., SSE, AVX1, AVX2, etc.), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 734/774 and a shared L2 cache unit 776, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

### Specific Exemplary In-Order Core Architecture

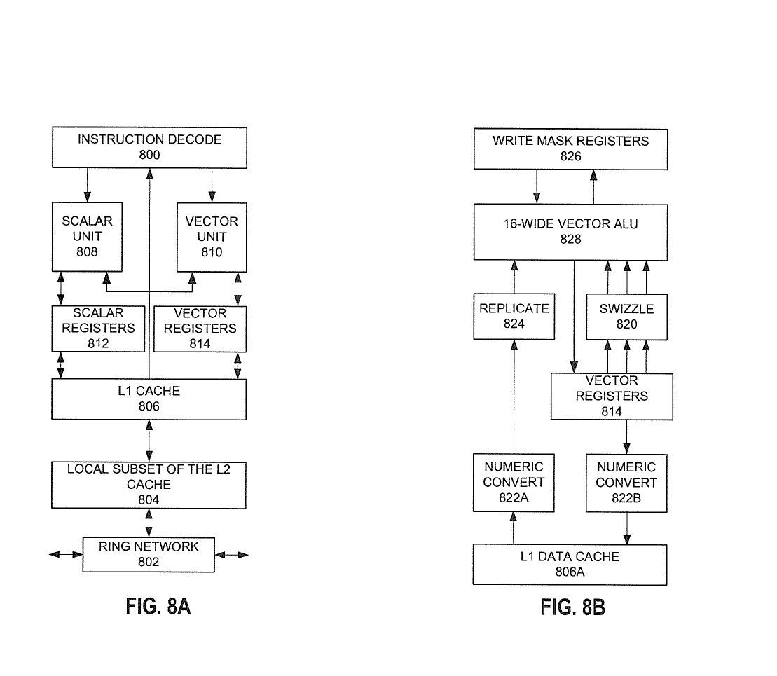

FIGS. 8A-B illustrate a block diagram of a more specific exemplary in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 8A is a block diagram of a single processor core, along with its connection to the on-die interconnect network 802 and with its local subset of the Level 2 (L2) cache 804, according to embodiments of the invention. In one embodiment, an instruction decoder 800 supports the x86 instruction set with a packed data instruction set extension. An L1 cache 806 allows low-latency accesses to cache memory into the scalar and vector units. While in one embodiment (to simplify the design), a scalar unit 808 and a vector unit 810 use separate register sets (respectively, scalar registers 812 and vector registers 814) and data transferred between them is written to memory and then read back in from a level 1 (L1) cache 806, alternative embodiments of the invention may use a different approach (e.g., use a single register set or include a communication path that allow data to be transferred between the two register files without being written and read back).

The local subset of the L2 cache 804 is part of a global L2 cache that is divided into separate local subsets, one per processor core. Each processor core has a direct access path to its own local subset of the L2 cache 804. Data read by a processor core is stored in its L2 cache subset 804 and can be accessed quickly, in parallel with other processor cores accessing their own local L2 cache subsets. Data written by a processor core is stored in its own L2 cache subset 804 and is flushed from other subsets, if necessary. The ring network ensures coherency for shared data. The ring network is bi-directional to allow agents such as processor cores, L2 caches and other logic blocks to communicate with each other within the chip. Each ring data-path is 1012-bits wide per direction.

FIG. 8B is an expanded view of part of the processor core in FIG. 8A according to embodiments of the invention. FIG. 8B includes an L1 data cache 806A part of the L1 cache 804, as well as more detail regarding the vector unit 810 and the vector registers 814. Specifically, the vector unit 810 is a 16-wide vector processing unit (VPU) (see the 16-wide ALU 828), which executes one or more of integer, single-precision float, and double-precision float instructions. The VPU supports swizzling the register inputs with swizzle unit 820, numeric conversion with numeric convert units 822A-B, and replication with replication unit 824 on the memory input. Write mask registers 826 allow predicating resulting vector writes.

Processor with Integrated Memory Controller and Graphics

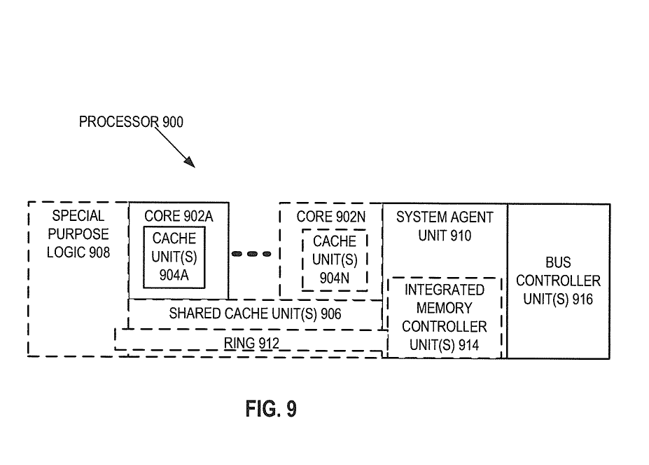

FIG. 9 is a block diagram of a processor 900 that may have more than one core, may have an integrated memory controller, and may have integrated graphics according to embodiments of the invention. The solid lined boxes in FIG. 9 illustrate a processor 900 with a single core 902A, a system agent 910, a set of one or more bus controller units 916, while the optional addition of the dashed lined boxes illustrates an alternative processor 900 with multiple cores 902A-N, a set of one or more integrated memory controller unit(s) 914 in the system agent unit 910, and special purpose logic 908.

Thus, different implementations of the processor 900 may include: 1) a CPU with the special purpose logic 908 being integrated graphics and/or scientific (throughput) logic (which may include one or more cores), and the cores 902A-N being one or more general purpose cores (e.g., general purpose in-order cores, general purpose out-of-order cores, a combination of the two); 2) a coprocessor with the cores 902A-N being a large number of special purpose cores intended primarily for graphics and/or scientific (throughput); and 3) a coprocessor with the cores 902A-N being a large number of general purpose in-order cores. Thus, the processor 900 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 900 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 906, and external memory (not shown) coupled to the set of integrated memory controller units 914. The set of shared cache units 906 may include one or more mid-level caches, such as level 2 (L2), level 3 (L3), level 4 (L4), or other levels of cache, a last level cache (LLC), and/or combinations thereof. While in one embodiment a ring based interconnect unit 912 interconnects the integrated graphics logic 908, the set of shared cache units 906, and the system agent unit 910/integrated memory controller unit(s) 914, alternative embodiments may use any number of well-known techniques for interconnecting such units. In one embodiment, coherency is maintained between one or more cache units 906 and cores 902-A-N.

In some embodiments, one or more of the cores 902A-N are capable of multi-threading. The system agent 910 includes those components coordinating and operating cores 902A-N. The system agent unit 910 may include for example a power control unit (PCU) and a display unit. The PCU may be or include logic and components needed for regulating the power state of the cores 902A-N and the integrated graphics logic 908. The display unit is for driving one or more externally connected displays.

The cores 902A-N may be homogenous or heterogeneous in terms of architecture instruction set; that is, two or more of the cores 902A-N may be capable of execution the same instruction set, while others may be capable of executing only a subset of that instruction set or a different instruction set.

### Exemplary Computer Architectures

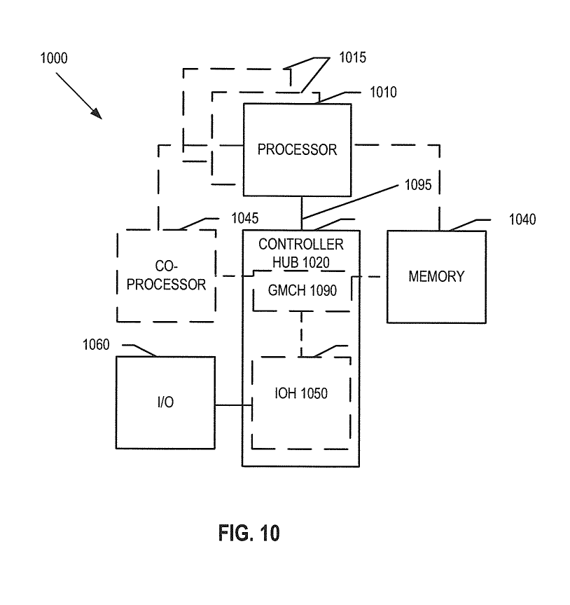

FIGS. 10-13 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 10, shown is a block diagram of a system 1000 in accordance with one embodiment of the present invention. The system 1000 may include one or more processors 1010, 1015, which are coupled to a controller hub 1020. In one embodiment the controller hub 1020 includes a graphics memory controller hub (GMCH) 1090 and an Input/Output Hub (IOH) 1050 (which may be on separate chips); the GMCH 1090 includes memory and graphics controllers to which are coupled memory 1040 and a coprocessor 1045; the IOH 1050 is couples input/output (I/O) devices 1060 to the GMCH 1090. Alternatively, one or both of the memory and graphics controllers are integrated within the processor (as described herein), the memory 1040 and the coprocessor 1045 are coupled directly to the processor 1010, and the controller hub 1020 in a single chip with the IOH 1050.

The optional nature of additional processors 1015 is denoted in FIG. 10 with broken lines. Each processor 1010, 1015 may include one or more of the processor cores described herein and may be some version of the processor 900.

The memory 1040 may be, for example, dynamic random access memory (DRAM), phase change memory (PCM), or a combination of the two. For at least one embodiment, the controller hub 1020 communicates with the processor(s) 1010, 1015 via a multi-drop bus, such as a frontside bus (FSB), point-to-point interface such as QuickPath Interconnect (QPI), or similar connection 1095.

In one embodiment, the coprocessor 1045 is a special-purpose processor, such as, for example, a high-throughput MIC processor, a network or communication processor, compression engine, graphics processor, GPGPU, embedded processor, or the like. In one embodiment, controller hub 1020 may include an integrated graphics accelerator.

There can be a variety of differences between the physical resources 1010, 1015 in terms of a spectrum of metrics of merit including architectural, micro-architectural, thermal, power consumption characteristics, and the like.

In one embodiment, the processor 1010 executes instructions that control data processing operations of a general type. Embedded within the instructions may be coprocessor instructions. The processor 1010 recognizes these coprocessor instructions as being of a type that should be executed by the attached coprocessor 1045. Accordingly, the processor 1010 issues these coprocessor instructions (or control signals representing coprocessor instructions) on a coprocessor bus or other interconnect, to coprocessor 1045. Coprocessor(s) 1045 accept and execute the received coprocessor instructions.

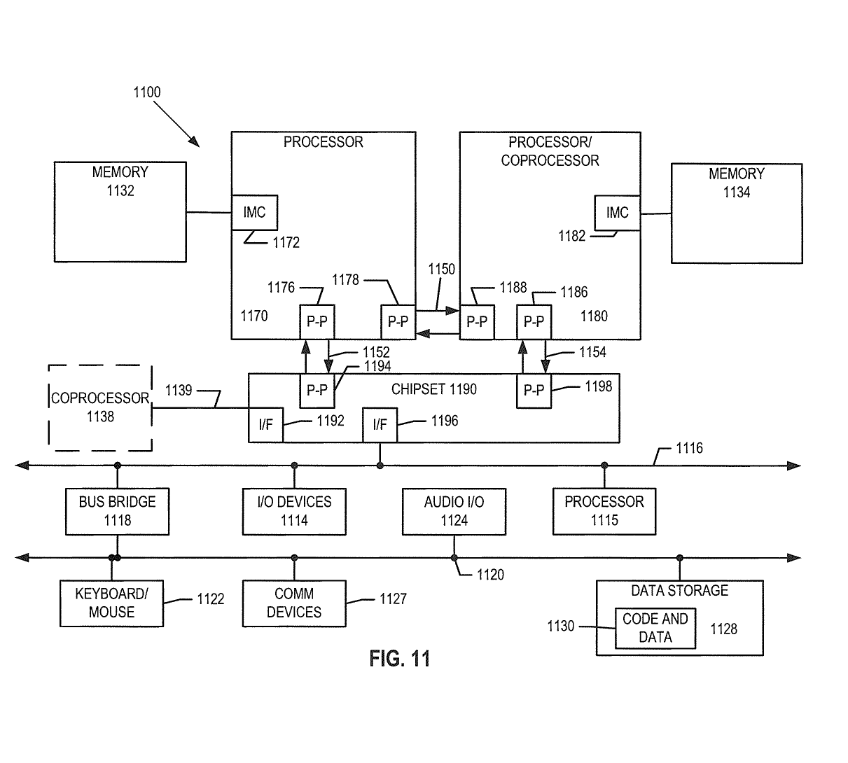

Referring now to FIG. 11, shown is a block diagram of a first more specific exemplary system 1100 in accordance with an embodiment of the present invention. As shown in FIG. 11, multiprocessor system 1100 is a point-to-point interconnect system, and includes a first processor 1170 and a second processor 1180 coupled via a point-to-point interconnect 1150. Each of processors 1170 and 1180 may be some version of the processor 900. In one embodiment of the invention, processors 1170 and 1180 are respectively processors 1010 and 1015, while coprocessor 1138 is coprocessor 1045. In another embodiment, processors 1170 and 1180 are respectively processor 1010 coprocessor 1045.

Processors 1170 and 1180 are shown including integrated memory controller (IMC) units 1172 and 1182, respectively. Processor 1170 also includes as part of its bus controller units point-to-point (P-P) interfaces 1176 and 1178; similarly, second processor 1180 includes P-P interfaces 1186 and 1188. Processors 1170, 1180 may exchange information via a point-to-point (P-P) interface 1150 using P-P interface circuits 1178, 1188. As shown in FIG. 11, IMCs 1172 and 1182 couple the processors to respective memories, namely a memory 1132 and a memory 1134, which may be portions of main memory locally attached to the respective processors.

Processors 1170, 1180 may each exchange information with a chipset 1190 via individual P-P interfaces 1152, 1154 using point to point interface circuits 1176, 1194, 1186, 1198. Chipset 1190 may optionally exchange information with the coprocessor 1138 via a high-performance interface 1139. In one embodiment, the coprocessor 1138 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1190 may be coupled to a first bus 1116 via an interface 1196. In one embodiment, first bus 1116 may be a Peripheral Component Interconnect (PCI) bus, or a bus such as a PCI Express bus or another third generation I/O interconnect bus, although the scope of the present invention is not so limited.

As shown in FIG. 11, various I/O devices 1114 may be coupled to first bus 1116, along with a bus bridge 1118 which couples first bus 1116 to a second bus 1120. In one embodiment, one or more additional processor(s) 1115, such as coprocessors, high-throughput MIC processors, GPGPU's, accelerators (such as, e.g., graphics accelerators or digital signal processing (DSP) units), field programmable gate arrays, or any other processor, are coupled to first bus 1116. In one embodiment, second bus 1120 may be a low pin count (LPC) bus. Various devices may be coupled to a second bus 1120 including, for example, a keyboard and/or mouse 1122, communication devices 1127 and a storage unit 1128 such as a disk drive or other mass storage device which may include instructions/code and data 1130, in one embodiment. Further, an audio I/O 1124 may be coupled to the second bus 1120. Note that other architectures are possible. For example, instead of the point-to-point architecture of FIG. 11, a system may implement a multi-drop bus or other such architecture.

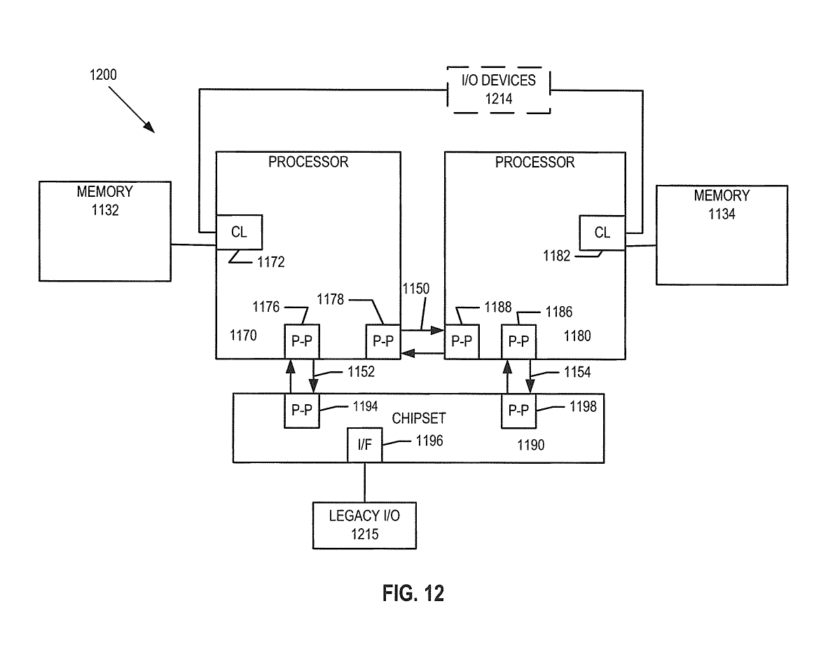

Referring now to FIG. 12, shown is a block diagram of a second more specific exemplary system 1200 in accordance with an embodiment of the present invention. Like elements in FIGS. 11 and 12 bear like reference numerals, and certain aspects of FIG. 11 have been omitted from FIG. 12 in order to avoid obscuring other aspects of FIG. 12.

FIG. 12 illustrates that the processors 1170, 1180 may include integrated memory and I/O control logic (“CL”) 1172 and 1182, respectively. Thus, the CL 1172, 1182 include integrated memory controller units and include I/O control logic. FIG. 12 illustrates that not only are the memories 1132, 1134 coupled to the CL 1172, 1182, but also that I/O devices 1214 are also coupled to the control logic 1172, 1182. Legacy I/O devices 1215 are coupled to the chipset 1190.

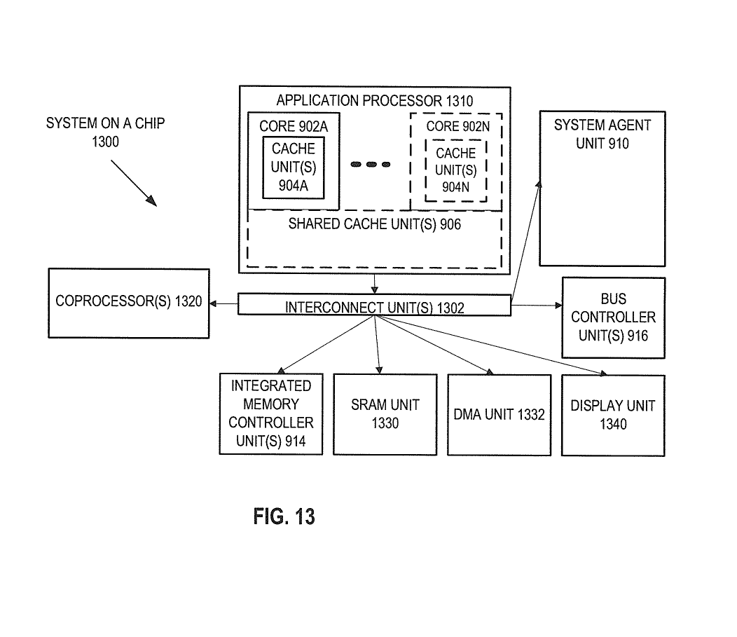

Referring now to FIG. 13, shown is a block diagram of a SoC 1300 in accordance with an embodiment of the present invention. Similar elements in FIG. 9 bear like reference numerals. Also, dashed lined boxes are optional features on more advanced SoCs. In FIG. 13, an interconnect unit(s) 1302 is coupled to: an application processor 1310 which includes a set of one or more cores 202A-N and shared cache unit(s) 906; a system agent unit 910; a bus controller unit(s) 916; an integrated memory controller unit(s) 914; a set or one or more coprocessors 1320 which may include integrated graphics logic, an image processor, an audio processor, and a video processor; an static random access memory (SRAM) unit 1330; a direct memory access (DMA) unit 1332; and a display unit 1340 for coupling to one or more external displays. In one embodiment, the coprocessor(s) 1320 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 1130 illustrated in FIG. 11, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

What is claimed is:

1. An apparatus comprising:
an extended register set partitioned into a plurality of banks;
a current bank register to provide a pointer to one of the banks that is currently active; and
execution circuitry coupled to the extended register set and the current bank register, the execution circuitry to:
receive an instruction for exchanging contexts of two user-level threads including a first thread and a second thread, wherein the first thread having a first context saved in a first one of the banks and the second thread having a second context saved in a second one of the banks,
change the pointer from the first bank to the second bank in response to the instruction, and
execute the second thread using the second context stored in the second bank.

2. The apparatus of claim 1, wherein a copy of the contexts is stored in a plurality of memory regions corresponding to the plurality of banks of the extended register set.

3. The apparatus of claim 2, further comprising snoop circuitry to track access to the memory regions, and to trigger an event for synchronizing the contexts between an area of the memory regions and a corresponding bank of the extended register set when the access is detected.

4. The apparatus of claim 1, further comprising a plurality of vector registers divided into a plurality of partitions, wherein a copy of the contexts is stored in the plurality of partitions corresponding to the plurality of banks of the extended register set.

5. The apparatus of claim 4, wherein each of the vector registers has one or more state bits associated therewith to indicate whether a latest copy of a given context is stored in the vector registers or in the extended register set.

6. The apparatus of claim 1, further comprising decoder circuitry coupled to the execution circuitry to map a register referenced by a given user-level thread into a corresponding bank of the extended register set.

7. The apparatus of claim 1, wherein the execution circuitry unconditionally switches to the second context in response to the instruction.

8. The apparatus of claim 1, further comprising front end circuitry coupled to the execution circuitry to determine whether a condition is met for switching to the second context.

9. The apparatus of claim 1, wherein the instruction is one of a pair of instructions that mark the boundary of an instruction block that includes a plurality of instructions, and wherein each instruction in the instruction block is a candidate for context switch.

10. The apparatus of claim 1, further comprising a mask register coupled to the execution circuitry, the mask register comprising a plurality of mask bits, wherein each mask bit is associated with one of the banks and indicates whether the one of the banks has been deactivated for context switching.

11. A method comprising:
executing by a processor a first thread using a first context stored in a first one of banks of an extended register set, wherein the first thread is a user-level thread;
receiving by the processor an instruction for exchanging contexts of the first thread and a second thread, wherein the second thread is another user-level thread having a second context saved in a second one of the banks of the extended register set;
changing a register pointer, which points to the first bank as a currently active bank, to the second bank in response to the instruction; and
executing by the processor the second thread using the second context stored in the second bank.

12. The method of claim 11, wherein a copy of the contexts is stored in a plurality of memory regions corresponding to the plurality of banks of the extended register set.

13. The method of claim 12, further comprising:
tracking access to the memory regions; and
triggering an event for synchronizing the contexts between an area of the memory regions and a corresponding bank of the extended register set when the access is detected.

14. The method of claim 11, wherein a copy of the contexts is stored in a plurality of partitions of vector registers corresponding to the plurality of banks of the extended register set.

15. The method of claim 14, wherein each of the vector registers has one or more state bits associated therewith to indicate whether a latest copy of a given context is stored in the vector registers or in the extended register set.

16. The method of claim 11, wherein executing the instruction causes switching to the second context unconditionally.

17. The method of claim 11, wherein executing the instruction causes determining whether a condition is met for switching to the second context.

18. The method of claim 11, wherein the instruction is one of a pair of instructions that mark the boundary of an instruction block that includes a plurality of instructions, and wherein each instruction in the instruction block is a candidate for context switch.

19. The method of claim 11, further comprising executing the instruction without involvement of an operating system.

20. A system comprising:
memory; and
a processor coupled to the memory, the processor comprising:
an extended register set partitioned into a plurality of banks,
a current bank register to provide a pointer to one of the banks that is currently active, and
execution circuitry coupled to the extended register set and the current bank register, the execution circuitry to receive an instruction for exchanging contexts of two user-level threads including a first thread and a second thread, wherein the first thread having a first context saved in a first one of the banks and the second thread having a second context saved in a second one of the banks, to change the pointer from the first bank to the second bank in response to the instruction, and to execute the second thread using the second context stored in the second bank.

21. The system of claim 20, wherein a copy of the contexts is stored in a plurality of memory regions of the memory corresponding to the plurality of banks of the extended register set.

22. The system of claim 20, further comprising a plurality of vector registers divided into a plurality of partitions, wherein a copy of the contexts is stored in the plurality of partitions corresponding to the plurality of banks of the extended register set.
